(19) United States
(12) Patent Application Publication
(10) Pub. No.: US 2009/0139052 A1
(43) Pub. Date: Jun. 4, 2009

(54) HANDLE ELEMENT

(75) Inventor: Antje Boenisch, Bielefeld (DE)

Correspondence Address: GAUTHIER & CONNORS, LLP, 225 FRANKLIN STREET, SUITE 2300, BOSTON, MA, 02110, US

(73) Assignee: SCHUCO INTERNATIONAL KG, Bielefeld (DE)

(21) Appl. No.: 12/210,411

(22) Filed: Sep. 15, 2008

Related U.S. Application Data
(63) Continuation of application No. PCT/EP2007/052538, filed on Mar. 16, 2007.

(30) Foreign Application Priority Data
Mar. 20, 2006 (DE) 10 2006 013 027.8

(51) Int. Cl. E05B 1/00

(52) U.S. Cl. 16/111.1; 16/412

(57) ABSTRACT

A handle element (1) for a window or a door, comprises a handle part (2), on or in which a power supply unit (17), a transmitter module (18), an antenna, a switching unit (6) are provided. According to the invention the switching unit (6) has at least one switch (7, 8) for actuating a peripheral device that can be triggered via the transmitter module (18) and the antenna. The handle element (1) can thus also take over a control function.

### PRIORITY INFORMATION

This application claims the benefit of International Patent Application Serial No. PCT/EP2007/052538 filed on Mar. 16, 2007 and claims priority to German Application Serial No. 10 2006 013 027.8, filed on Mar. 20, 2006.

### BACKGROUND OF THE INVENTION

1. Field of the Invention

The present invention relates to a handle element for a window or a door, with a handle part, on or in which a power supply unit, a transmitter module, an antenna and a switching unit are provided.

2. Brief Description of the Art

DE 10 2004 018 063 shows a window handle for actuating an automatic window, wherein the window hand lever switches the locking and the opening drive via different switch positions. The window can thus be moved via drive means instead of mechanical means. The switching elements can thereby be triggered either by electric lines or wirelessly, in order to actuate a corresponding locking or movement of a window panel. DE 10 2004 060 202 shows a window handle in which switching buttons are provided on the handle, by means of which switching buttons the opening of the window, in particular tilting, is controlled. To this end, a rocker is coupled with a corresponding switching device so that corresponding locking devices and drives on the window can be moved.

### SUMMARY OF THE INVENTION

The object of the present invention is therefore to create a handle element for a window or a door, which can also perform control functions in addition to the mechanical function of the handle element.

This object is attained with a handle element with the features of claim 1.

According to the invention, the switching unit has a least one switch for actuating a peripheral device that can be triggered via the transmitter module and the antenna. The handle element, which is usually freely accessible on a window or a door, can thus take over a control function in order to control peripheral devices, such as ventilation elements or shading elements or other peripheral devices. This renders possible a higher functionality of the handle element, which also forms a switching unit in addition to the mechanical coupling to a window or a door.

For a visually attractive embodiment of the handle element, the handle element has on the handle part a closeable receptacle for the power supply unit, the transmitter module, the switching unit and the antenna. The individual components can thus be arranged in a concealed manner, and the user is confronted only by the necessary switches and display means in the visible area.

In order to ensure a good signal transmission, the receptacle can be closed by a cover of plastic, and the handle neck and the handle part can be of metal. The shielding by metal components is thus reduced, wherein the cover can be arranged on the back in the non-visible area.

For a compact construction, a printed circuit board is fixed in the receptacle, on which printed circuit board a switching unit, a transmitter module and an antenna are arranged.

The receptacle can thereby be arranged in the handle part as an elongated recess that extends essentially perpendicular to a handle neck. The printed circuit board with the antenna can thereby be arranged on the side facing towards the handle neck and thus remains easily accessible for maintenance and repair work.

According to a further embodiment of the invention, display means are provided on the handle part, which display means are coupled with a selector switch and display which peripheral device is currently selected. The handle element is thus easy to operate, wherein the user can use optical display means with text and/or pictograms in the selection of the peripheral device, as well as acoustic display means via a small loudspeaker.

Electric drive means for a window or a door, electrically driven skylight windows, electrically driven blinds, electrically driven ventilation controls, alarm systems, lighting, air-conditioning devices and/or heating devices can be provided as peripheral devices. Other electric devices can also be controlled as needed via a corresponding radio control through the handle element.

Preferably the handle element comprises a switching unit with a timing circuit to control the peripheral devices. Then, for example, a shading system as a peripheral device can be automatically raised and lowered or a ventilation can be carried out automatically at a specific time of day for a specific duration.

According to a preferred embodiment of the invention, the power supply unit comprises at least one battery, which is incorporated into the handle part in an interchangeable manner. The battery can then be replaced at regular intervals in order to be able to use the control function of the handle element for a long time.

In addition to the selector switch, the switching unit also has at least one switch for actuating a peripheral device, wherein the switch can be embodied as a rocker switch and can taken over functions such as open/closed, up/down, on/off, that is, takes over a corresponding control of the peripheral devices.

### BRIEF DESCRIPTION OF THE DRAWINGS

The invention is described in more detail below based on an exemplary embodiment with reference to the attached drawings. They show:

FIG. 1 A perspective view of an exemplary embodiment of a handle element according to the invention;

FIG. 2 A perspective view of the handle element of FIG. 1;

FIG. 3 A side view of the handle element of FIG. 1 and

FIG. 4 An exploded view of the handle element of FIG. 1.

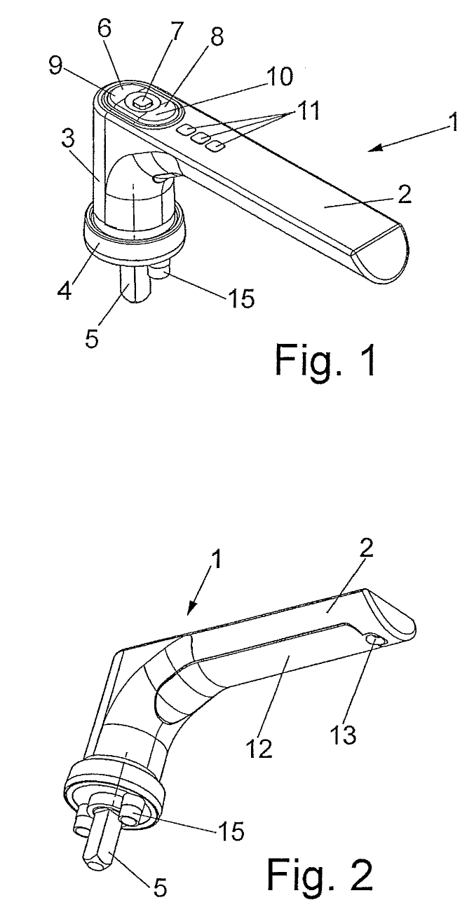

### DETAILED DESCRIPTION OF THE INVENTION

A handle element 1 for a window or a door comprises a handle element 2 for grasping with the hand, and a handle neck 3, which serves as connection to a window or a door, arranged essentially perpendicular thereto. A rosette 4 is thereby arranged around the handle neck 3, in which rosette the handle neck 3 is hinge-mounted. A squared end 5 is fixed, for example, clamped, pressed or screwed, in the handle neck 3, which squared end projects from the handle neck 3 and is used for the mechanical transfer of rotary motions into a fitting part, for example a tilt gear of a window or a door.

A switching unit 6 is located on the visible front of the handle part 2 which faces towards the interior of the room, which switching unit has a fingertip switch 7 that is embodied as a selector switch. Diverse peripheral devices can be selected by pressing the fingertip switch 7. Furthermore, a rocker switch 8 is arranged adjacent to the finger-tip switch 7, which rocker switch actuates the selected peripheral devices, wherein an area 9 arranged above the finger-tip switch 7 can trigger switching-on or other actuations, for example, for raising shading elements, while an area 10 arranged below the finger-tip switch 7 can trigger switching-off or other functions of a peripheral device for lowering a shading element. The fingertip switch 7 thereby lies in the center between the areas 9 and 10 of the rocker switch 8.

Furthermore, display means 11 are provided on the handle part 2, which display means can be illuminated by diodes, in order to provide the user with the information on which peripheral device has just been selected by means of the finger-tip switch 7. Accordingly, the display means 11 can be provided with text, pictograms or other markings so that the user can see at a glance the assignment between the selected peripheral device and the fingertip switch 7. Moreover, it is possible to deliver the selection of the fingertip switch 7 also via acoustic signals. A peripheral device is thus selected by means of a fingertip switch 7 which peripheral device is made visible via the display means 11. Subsequently, a corresponding control of the peripheral device can then be carried out via actuation of the rocker switch 8 in the upper area 9 or the lower area 10.

Electric drive means for a window or a door for opening or closing, electrically driven skylight windows for ventilation, electrically driven blinds as shading elements inside or outside, electrically driven ventilation controls, alarm systems, lighting, air-conditioning devices and/or heating devices can be provided as peripheral devices.

In FIG. 2 the handle element is shown from below and a cover 12 can be seen which closes a receptacle in the handle part 2. The cover 12 can be fixed to the handle part via a screw channel 13. It is also possible to fix the cover 12 via corresponding locking connections.

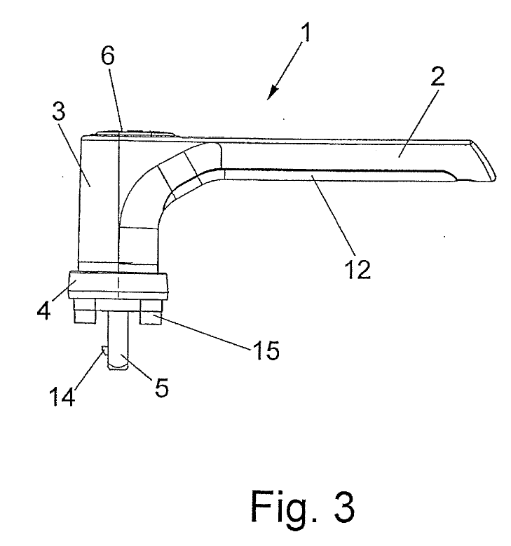

In FIG. 3 the handle element 1 is shown from the side, wherein a latch hook 14 is discernible on the squared end 5, which latch hook can engage with a latch recess on the tilt gear of a window or a door. The handle element 1 can thus be easily assembled or disassembled in that the squared end 5 is correspondingly inserted with the latch hook 14. Furthermore, the rosette 4 can be securely screwed to the window element or door element for the pivot bearing of the handle element 1. Pins 15 are provided for the safe installation and exact positioning of the rosette 4, through which pins mounting screws for the engagement with the rosette 4 can be also provided.

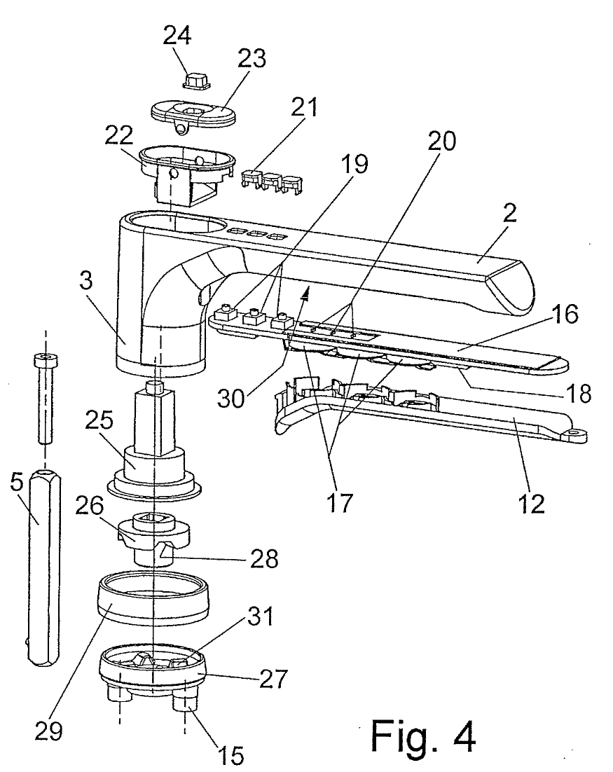

In FIG. 4 the handle element 1 is shown in an exploded view. An elongated recess 30 is arranged on the side of the handle part 2 facing towards the handle neck 3, in which elongated recess a printed circuit board 16 if fixed. A power supply unit 17 with individual batteries, the transmitter module 18 an antenna, not shown in further detail, as well as switches 19 for the finger-tip switch 7 and the switching areas 9 and 10 are provided on the printed circuit board 16. Furthermore, light-emitting diodes 20 are installed on the printed circuit board 16 which are respectively used to illuminate a display means 11. The light-emitting diodes 20 are thereby arranged protected via transparent cover caps 21.

The switching unit 6 has a switch housing 22 in which a rocker 23 is arranged in a moveable manner. A cover 24 of the fingertip switch 7 is located in the center of the rocker. Only the switching unit 6 and the display means 11 are thus to be seen on the front of the handle part 2, so that a simple operation is ensured. The electronic components on the printed circuit board 16 are thereby arranged in an externally protected manner. To this end, the recess 30 on the handle part 2 is closed via a cover 12 of plastic.

In order to guarantee the best possible radio transmission, an insulated bushing 25 is provided on the handle neck 3, which insulated bushing separates the handle element 1 with all of its electronics from the squared end 5 and from the rosette 4. The rosette 4 for the pivot bearing and locking of the handle element 1 comprises essentially a rosette pivot shoe 26 in which the squared end 5 is accommodated, and a rosette pivot shoe bushing 27. The fastening pins 15 are provided in this rosette pivot shoe bushing 27. The pivot shoe 26 and the pivot shoe bushing 27 have corresponding pins 31 or recesses 28 in order to render possible a locking position of the handle element 1 arranged offset by 90°. The antenna on the printed circuit board 16 can be arranged by a corresponding winding on the end of the handle part 2 facing away from the handle neck 3, wherein a radiation through the cover 12 of plastic is possible. Furthermore it is possible to boost the antenna through corresponding lines on the outside of the handle part 2.

The handle element 1 shown thus provides a control unit with which desired peripheral devices can be actuated. Furthermore, it is possible to provide a timing circuit on the printed circuit board for an automatic actuation, so that a peripheral device can be triggered at a specific time, for example, for ventilation or within the scope of a wake-up function by raising a blind. Moreover, the control on the printed circuit board 16 can be coupled with sensors for an automatic control, e.g., with a wind measuring device, a light sensor a CO₂ sensor or another suitable sensor.

In the exemplary embodiment shown, a fingertip switch 7 is to be provided as a selector switch, and a rocker switch 8 for actuating the peripheral devices. Of course, it is also possible to provide several switches on the handle part 2 for actuating the peripheral devices. Furthermore, it is possible for the fingertip switch 7 to be arranged spaced apart from the rocker switch 8 in order to avoid malfunctions.

What we now claim is:

1. A handle element for a window or a door, with a handle part comprising:
a) a power supply unit,
b) a transmitter module,
c) an antenna, and
d) a switching unit
wherein the switching unit has at least one switch for actuating a peripheral device that can be triggered via the transmitter module and the antenna, such that the switching unit has a selector switch for selecting the peripheral device to be triggered and at least one switch for actuating the peripheral device.

2. The handle element according to claim 1, wherein a closeable receptacle for the power supply unit, the transmitter module, the switching unit and the antenna is provided on the handle part.

3. The handle element according to claim 1, wherein the receptacle can be closed by a cover of plastic and the handle neck and the handle part are of metal.

4. The handle element according to claim 1, wherein a printed circuit board is fixed in the receptacle, on which printed circuit board a switching unit, a transmitter module and an antenna are arranged.

5. The handle element according to claim 1, wherein display means are provided on the handle part, which display means are coupled with a selector switch and display which a peripheral device is currently selected.

6. The handle element according to claim 1 wherein an electric drive means for a window or a door, electrically driven skylight windows, electrically driven blinds, electrically driven ventilation controls, alarm systems, lighting, air-conditioning devices and/or heating devices are provided as a peripheral device.

7. The handle element according to claim 1 wherein the switching unit has a timing circuit to control the peripheral devices.

8. The handle element according to claim 1 wherein the power supply unit comprises at least one battery, which is incorporated into the handle part in an interchangeable manner.

9. The handle element according to claim 1, wherein the handle element has a handle neck that can be connected to a window or door and a handle part extending essentially perpendicular to the handle neck, in which handle part an elongated recess is provided to accommodate a printed circuit board.

10. The handle element according to claim 9, wherein the switching unit is arranged on the side of the handle part facing away from the handle neck and the closeable receptacle is arranged on the side of the handle part facing towards the handle neck.

11. (canceled)

12. The handle element according to claim 1, wherein an insulated bushing is provided that separates the handle element from adjacent metallic components.
